(19) United States
(12) Patent Application Publication
(10) Pub. No.: US 2006/0288096 A1
(43) Pub. Date: Dec. 21, 2006

(54) Integrated monitoring for network and local internet protocol traffic

(76) Inventor: Wai Yim, San Jose, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/155,083

(22) Filed: Jun. 17, 2005

(51) Int. Cl. G06F 15/173

(52) U.S. Cl. 709/224

(57) ABSTRACT

An apparatus comprises a communication function monitoring module comprising a communication function call detecting module to detect communication function calls generated by one or more applications, and a communication function call reporting module to send information describing one or more of the communication function calls to a traffic monitoring module; and a packet monitoring module comprising a packet detecting module to detect packets handled by a network interface hardware driver for the one or more applications, and a packet reporting module to send information describing one or more of the packets to the traffic monitoring module. The functionality and variations thereof of such apparatus are also embodied in methods and computer programs.

### BACKGROUND

The present invention relates generally to data communications. More particularly, the present invention relates to integrated monitoring for network and local internet protocol (IP) traffic.

In the current computing environment many applications such as Internet-based server applications involve multiple processes, some of which run on the same computer and some of which run on different computers. Regardless of where they run, these processes communicate with one another using the IP protocol. For example, a H.323 videoconferencing Multipoint Control Unit (MCU) server process may create a transmission control protocol (TCP) connection with a web server running on the same local computer.

Occasionally it is desirable to debug such applications. One useful tool is a conventional packet sniffer, which records all raw IP packets entering and exiting a computer. However, such packet sniffers are unable to monitor inter-process IP connections between processes on the same computer.

### SUMMARY

In general, in one aspect, the invention features an apparatus comprising a communication function monitoring module comprising a communication function call detecting module to detect communication function calls generated by one or more applications, and a communication function call reporting module to send information describing one or more of the communication function calls to a traffic monitoring module; and a packet monitoring module comprising a packet detecting module to detect packets handled by a network interface hardware driver for the one or more applications, and a packet reporting module to send information describing one or more of the packets to the traffic monitoring module.

Some embodiments comprise a communication function call filter module to select the one or more of the communication function calls. Some embodiments comprise a packet filter module to select the one or more of the packets. Some embodiments comprise the traffic monitoring module. In some embodiments, the communication function call detecting module comprises a dynamic link library module in communication with a Microsoft Windows Winsock module which is in communication with the one or more applications, and a network protocol driver which is in communication with the network interface hardware driver.

In general, in another aspect, the invention features a method comprising detecting communication function calls generated by one or more applications; sending information describing one or more of the communication function calls to a traffic monitoring module; detecting packets handled by a network interface hardware driver for the one or more applications; and sending information describing one or more of the packets to the traffic monitoring module.

Some embodiments comprise selecting the one or more of the communication function calls. Some embodiments comprise selecting the one or more of the packets. Some embodiments comprise selecting the one or more of the communication function calls. In some embodiments, the one or more of the communication function calls are selected according to predefined communication function call filter criteria, further comprising, and the method comprises establishing the communication function call filter criteria according to user input. Some embodiments comprise selecting the one or more of the packets. In some embodiments, the one or more of the packets are selected according to predefined packet filter criteria, and the method further comprises establishing the packet filter criteria according to user input. Some embodiments comprise a computer program for performing the method. Some embodiments comprise an apparatus to perform the method.

In general, in still another aspect, the invention features a method comprising receiving first reports comprising descriptions of communication function calls generated by one or more applications; receiving second reports comprising descriptions of one or more packets handled by a network interface hardware driver for the one or more applications; and generating a communication status report based on one or more of the descriptions of the communication function calls and one or more of the descriptions of the one or more packets.

Some embodiments comprise selecting the one or more of the descriptions of the communication function calls in the first reports. Some embodiments comprise selecting the one or more of the descriptions of the packets described in the second reports. Some embodiments comprise presenting the network status report to a user. Some embodiments comprise configuring the communication function call filter module and the packet filter module according to user input. Some embodiments comprise a computer program for performing the method. Some embodiments comprise an apparatus to perform the method.

In general, in a further aspect, the invention features an apparatus comprising means for monitoring communication functions comprising communication function call detecting means for detecting communication function calls generated by one or more applications, and communication function call reporting means for sending information describing one or more of the communication function calls to a traffic monitoring module; and means for monitoring packets comprising packet detecting module means for detecting packets handled by a network interface hardware driver for the one or more applications, and packet reporting means for sending information describing one or more of the packets to the traffic monitoring module.

Some embodiments comprise communication function call filter means for selecting the one or more of the communication function calls. Some embodiments comprise packet filter module means for selecting the one or more of the packets. Some embodiments comprise the traffic monitoring module.

The details of one or more implementations are set forth in the accompanying drawings and the description below. Other features will be apparent from the description and drawings, and from the claims.

### DESCRIPTION OF DRAWINGS

FIG. 1 shows a conventional software stack for an operating system such as Microsoft Windows.

FIG. 2 shows an integrated monitoring system according to a preferred embodiment.

FIG. 3 shows detail of the communication function call monitoring module of FIG. 2 according to a preferred embodiment.

FIG. 4 shows detail of the packet monitoring module of FIG. 2 according to a preferred embodiment.

FIG. 5 shows detail of the traffic monitoring module of FIG. 2 according to a preferred embodiment.

FIG. 6 shows a method for the software stack of FIG. 2 according to a preferred embodiment.

FIG. 7 shows a method for the traffic monitoring module of FIG. 2 according to a preferred embodiment.

The leading digit(s) of each reference numeral used in this specification indicates the number of the drawing in which the reference numeral first appears.

### DETAILED DESCRIPTION

Embodiments of the present invention provide integrated monitoring for network and local Internet Protocol (IP) traffic. Embodiments of the present invention monitor not only communication between processes running on different computers, but also communication between processes running on the same computer. While embodiments of the present invention are described with reference to the Microsoft Windows operating system, other embodiments are capable of working with other operating systems, as will be apparent to one skilled in the relevant arts after reading this description.

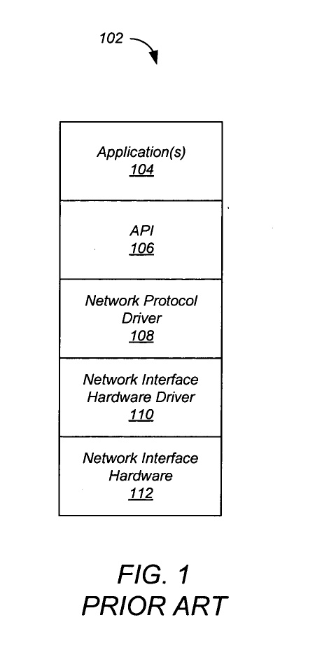

FIG. 1 shows a conventional software stack 102 for an operating system such as Microsoft Windows. Software stack 102 comprises one or more applications 104 in communication with a communication application programming interface (API) 106 such as Microsoft Winsock, which is in communication with network protocol driver 108 such as a Transmission Control Protocol/Internet Protocol (TCP/IP) driver, which is in communication with a network interface hardware driver 110 such as a network interface card (NIC) driver, which is in communication with network interface hardware 112 such as a network interface card (NIC).

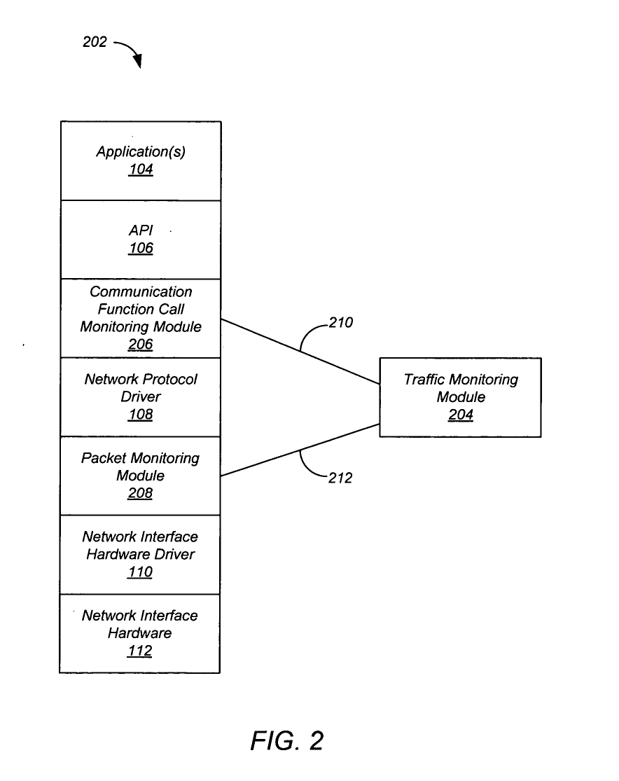

FIG. 2 shows an integrated monitoring system 200 according to a preferred embodiment. Integrated monitoring system 200 comprises a software stack 202 and a traffic monitoring module 204. Software stack 202 and traffic monitoring module 204 may reside on different computers or on the same computer.

Software stack 202 is similar to software stack 102 of FIG. 1, but includes two additional modules that together form a communication monitoring module: a communication function call monitoring module 206 and a packet monitoring module 208. Modules 206 and 208 communicate with traffic monitoring module 204 via links 210 and 212 respectively, as described in detail below.

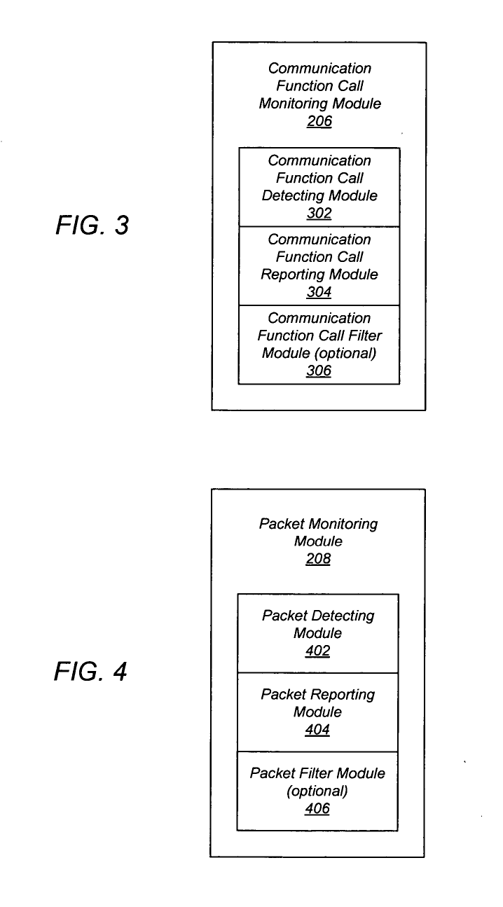

FIG. 3 shows detail of communication function call monitoring module 206 according to a preferred embodiment. Communication function call monitoring module 206 comprises a communication function call detecting module 302 to detect communication function calls generated by applications 104 and a communication function call reporting module 304 to send information describing one or more of the communication function calls to traffic monitoring module 204. Function call monitoring module 206 optionally comprises a communication function call filter module 306 to select one or more of the communication function calls detected by communication function call detecting module 302 to be included in the reports sent by communication function call reporting module 304.

FIG. 4 shows detail of packet monitoring module 208 according to a preferred embodiment. Packet monitoring module 208 comprises a packet detecting module 402 to detect packets handled by network interface hardware driver 110 for applications 104 (that is, to detect packets transmitted for, or received for, applications 104). Packet monitoring module 208 also comprises a packet reporting module 404 to send information describing one or more of the packets to traffic monitoring module 204. Packet monitoring module 208 optionally comprises a packet filter module 406 to select one or more of the packets detected by packet detecting module 402 to be included in the reports sent by packet reporting module 404.

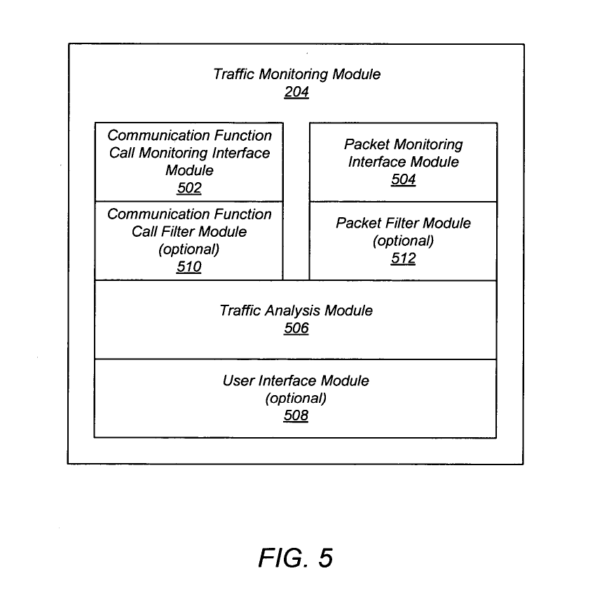

FIG. 5 shows detail of traffic monitoring module 204 according to a preferred embodiment. Traffic monitoring module 204 comprises a communication function call monitoring interface module 502 to receive reports comprising descriptions of communication function calls generated by applications 104 from communication function call reporting module 304 of communication function call monitoring module 206 and a packet monitoring interface module 504 to receive reports comprising descriptions of packets handled by network interface hardware driver 110 for applications 104 from packet reporting module 404 of packet monitoring module 208. Traffic monitoring module 204 further comprises a traffic analysis module 506 to generate network status reports, alerts, and the like based on the descriptions of the communication function calls and the descriptions of the one or more packets. Traffic monitoring module 204 optionally comprises a user interface module 508 to present the network status reports and the like to a user.

Traffic monitoring module 204 optionally comprises either or both of a communication function call filter module 510 and a packet filter module 512. Communication function call filter module 510 selects one or more of the descriptions of the communication function calls for analysis in generating the network status reports. Similarly, packet filter module 512 selects one or more of the descriptions of the packets for analysis in generating the network status reports. In embodiments comprising one or both of communication function call filter module 510 and packet filter module 512, user interface module 508 permits a user to configure filters 510 and 512.

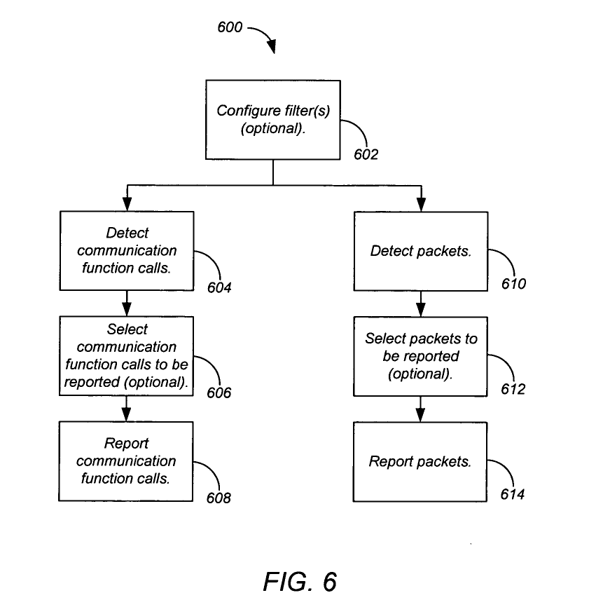

FIG. 6 shows a method 600 for software stack 202 according to a preferred embodiment. In embodiments comprising one or both of optional communication function call filter module 306 and optional packet filter module 406, method 600 optionally comprises configuring one or both of filters 306 and 406 (step 602), for example according to user input which can be provided via user interface module 508 of traffic monitoring module 204. In the case of function call filter module 306, configuring comprises selecting which communication function calls should be reported to traffic monitoring module 204. In the case of optional packet filter module 406, configuring comprises selecting which packets should be reported to traffic monitoring module 204.

Communication function call detecting module 302 detects communication function calls generated by applications 104 (step 604). Communication function calls include function calls by applications 104 to communication API 106 to make and break communication connections, send and receive packets, and the like. In Microsoft Windows environments, communication function call monitoring module 206 is implemented as a Winsock2 hooking dynamically linked library (DLL) that attaches to Winsock2 standard socket function calls using the Winsock2 layered service provider (LSP) mechanism. In other environments, other implementations can be used. According to these embodiments, when a socket-based application 104 makes a Winsock2 socket function call (for example, bind( ), connect( ), accept( ), send( )/sendto( ), recv( )/recvfrom( ), and the like), the corresponding function of the LSP DLL is invoked. The LSP DLL can examine and/or modify any data passed to its functions.

In embodiments employing optional communication function call filter module 306, filter module 306 selects one or more of the communication function calls to be reported to traffic monitoring module 204 (step 606).

Communication function call reporting module 304 sends information describing the communication function calls to traffic monitoring module 204 (step 608) via link 210. In Microsoft Windows environments, link 210 is preferably implemented using the Microsoft Named Pipe mechanism, although any inter-process communication mechanism can be used. In other environments, other implementations can be used.

Packet detecting module 402 detects packets handled by network interface hardware driver 110 for applications 104 (step 610). Packet detecting module 402 is thereby invoked for each packet sent by, or received by, the computer on which module 402 resides. In Microsoft Windows environments, packet detecting module 402 preferably provides miniport interfaces to network protocol driver 108 that receive packets sent by applications 104, and provides protocol interfaces to network interface hardware driver 110 that receive packets sent to applications 104. In other environments, other implementations can be used.

In embodiments employing optional packet filter module 406, filter module 406 selects one or more of the packets to be reported to traffic monitoring module 204 (step 612) according to predefined packet filter criteria, which may be configured by a user. For example, the packet filter criteria can select only those packets associated with particular TCP or UDP ports, only those packets associated with particular TCP events such as SYN, SYN+ACK, FIN+ACK, RST, and the like. Packet reporting module 404 sends information describing the packets to traffic monitoring module 204 (step 614).

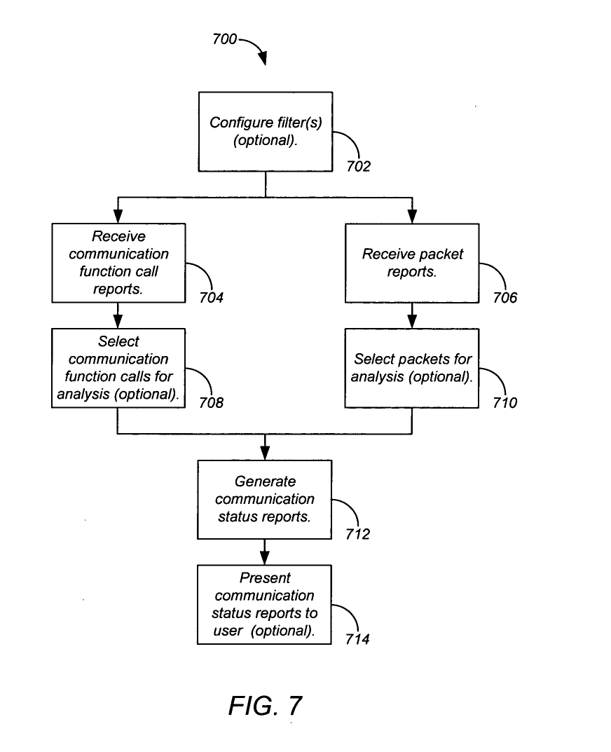

FIG. 7 shows a method 700 for traffic monitoring module 204 according to a preferred embodiment. In embodiments comprising one or both of optional communication function call filter module 510 and optional packet filter module 512, method 600 optionally comprises configuring one or both of filters 510 and 512 (step 702), for example according to user input which can be provided via user interface module 508. In the case of function call filter module 510, configuring comprises selecting which communication function calls reported by communication function call monitoring module 206 should be analyzed by traffic monitoring module 204. In the case of optional packet filter module 406, configuring comprises selecting which packets reported by packet monitoring module 208 should be analyzed by traffic monitoring module 204. The filter criteria employed by communication function call filter module 510 and optional packet filter module 512 can be as described above for communication function call filter module 306 and packet filter module 406.

Communication function call monitoring interface module 502 receives reports comprising descriptions of communication function calls generated by applications 104 from communication function call reporting module 304 of communication function call monitoring module 206 (step 704).

Packet monitoring interface module 504 receives reports comprising descriptions of packets handled by network interface hardware driver 110 for applications 104 from packet reporting module 404 of packet monitoring module 208 (step 706).

In embodiments employing optional communication function call filter module 510, filter module 510 selects one or more of the reported communication function calls for analysis (step 708). In embodiments employing optional packet filter module 512, filter module 512 selects one or more of the reported packets for analysis (step 710).

Traffic analysis module 506 generates communication status reports, alerts, and the like based on the descriptions of the communication function calls and the descriptions of the one or more packets (step 712). User interface module 508 optionally presents the communication status reports to a user (step 714).

Traffic analysis module 506 can employ any sort of analysis, for example for debugging or performance purposes. For example, traffic analysis module can detect out-of-order packets, packet retransmissions, and the like.

As another example, traffic analysis module 506 can monitor the buffering status of network protocol driver 108. For example, when an application 104 exchanges TCP/IP data with a network, network protocol driver 108 buffers the data until it is received (by application 104 for incoming data, and by network interface hardware driver 110 for outgoing data). This buffering generally improves performance and throughput, as is well known in the relevant arts. However, when the data buffered becomes large, its latency increases. For real-time data such as videoconferencing data, this latency adversely affects the interactive experience of the user. By analyzing the send( ), sendto( ), recv( ), and recvfrom( ) communication function calls of applications 104 and the packets having the PSH flag set, traffic analysis module 506 can determine the amount of data buffered.

As another example, traffic monitoring module 204 can report the establishment of a TCP connection by an application 104 to an application on a different computer. Communication function call monitoring module 206 reports the connect( ) function call from application 104. Packet monitoring module 208 reports the resulting TCP handshake packets. Communication function call monitoring module 206 then reports the return status of the connect( ) function call.

As another example, traffic monitoring module 204 can report the establishment of a TCP connection by one application 104 or process to another application 104 or process on the same computer. Communication function call monitoring module 206 reports the connect( ) function call having the computer's IP address as the destination address, and subsequently reports the return status of the connect( ) function call. Because this inter-process connection does not involve another computer, packet monitoring module 208 has no packets to report.

Embodiments of the present invention are especially useful in H.323 videoconferencing applications. Communication monitoring modules according to these embodiments can be incorporated in H.323 clients and servers for use in debugging connectivity issues, for example where a H.323 client is behind a network or local firewall. When used in conjunction with a remote desktop protocol such as Virtual Network Computing (VNC), embodiments of the present invention permit a technician to remotely monitor and correct client connectivity issues. In addition, embodiments of the present invention can check client registry settings such as Microsoft Internet Explorer Proxy Server settings to ensure proper client software setup.

On the H.323 videoconferencing server side, embodiments of the present invention can track network performance for each individual client connection. When the server is integrated with other local applications and processes such as web servers or local database servers, embodiments of the present invention can monitor communications between the applications and processes. In addition, client connectivity issues can be tracked through these multiple server applications and processes.

Embodiments of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits). Computer program instructions for implementing embodiments of the invention can also be carried on a suitable carrier wave.

A number of implementations of the invention have been described. Nevertheless, it will be understood that various modifications may be made without departing from the spirit and scope of the invention. Accordingly, other implementations are within the scope of the following claims.

What is claimed is:

1. An apparatus comprising:
a communication function monitoring module comprising
a communication function call detecting module to detect communication function calls generated by one or more applications, and
a communication function call reporting module to send information describing one or more of the communication function calls to a traffic monitoring module; and
a packet monitoring module comprising
a packet detecting module to detect packets handled by a network interface hardware driver for the one or more applications, and
a packet reporting module to send information describing one or more of the packets to the traffic monitoring module.

2. The apparatus of claim 1, further comprising:
a communication function call filter module to select the one or more of the communication function calls.

3. The apparatus of claim 1, further comprising:
a packet filter module to select the one or more of the packets.

4. The apparatus of claim 1, further comprising:
the traffic monitoring module.

5. The apparatus of claim 1:
wherein the communication function call detecting module comprises a dynamic link library module in communication with
a Microsoft Windows Winsock module which is in communication with the one or more applications, and
a network protocol driver which is in communication with the network interface hardware driver.

6. A method comprising:
detecting communication function calls generated by one or more applications;
sending information describing one or more of the communication function calls to a traffic monitoring module;
detecting packets handled by a network interface hardware driver for the one or more applications; and
sending information describing one or more of the packets to the traffic monitoring module.

7. The method of claim 6, further comprising:
selecting the one or more of the communication function calls.

8. The method of claim 7, wherein the one or more of the communication function calls are selected according to predefined communication function call filter criteria, further comprising:
establishing the communication function call filter-criteria according to user input.

9. The method of claim 6, further comprising:
selecting the one or more of the packets.

10. The method of claim 9, wherein the one or more of the packets are selected according to predefined packet filter criteria, further comprising:
establishing the packet filter criteria according to user input.

11. A medium or waveform containing a program of instructions that, when executed, is adapted to cause an instruction-executing device to perform the method of claim 6.

12. An apparatus configured to perform the method of claim 6.

13. A method comprising:
receiving first reports comprising descriptions of communication function calls generated by one or more applications;
receiving second reports comprising descriptions of one or more packets handled by a network interface hardware driver for the one or more applications; and
generating a communication status report based on one or more of the descriptions of the communication function calls and one or more of the descriptions of the one or more packets.

14. The method of claim 13, further comprising:
selecting the one or more of the descriptions of the communication function calls in the first reports.

15. The method of claim 13, further comprising:
selecting the one or more of the descriptions of the packets described in the second reports.

16. The method of claim 13, further comprising:
presenting the network status report to a user.

17. The method of claim 13:
configuring the communication function call filter module and the packet filter module according to user input.

18. A medium or waveform containing a program of instructions that, when executed, is adapted to cause an instruction-executing device to perform the method of claim 13.

19. An apparatus configured to perform the method of claim 13.
